(19) United States
(12) Patent Application Publication
(10) Pub. No.: US 2014/0189076 A1
(43) Pub. Date: Jul. 3, 2014

(54) CONFIGURATION OF COMPUTER SYSTEMS VIA SIMPLE OBJECT ACCESS PROTOCOL CONNECTIONS

(71) Applicant: INTERNATIONAL BUSINESS MACHINES CORPORATION, Armonk, NY (US)

(72) Inventors: James D. Creasman, Apex, NC (US); Jeffrey R. Hoy, Southern Pines, NC (US); Andrew J. Ivory, Wake Forest, NC (US); Barry J. Pellas, Raleigh, NC (US)

(73) Assignee: International Business Machines Corporation, Armonk, NY (US)

(21) Appl. No.: 13/733,228

(22) Filed: Jan. 3, 2013

(51) Int. Cl. G06F 15/177

(52) U.S. Cl. CPC G06F 15/177
USPC 709/220

(57) ABSTRACT

Embodiments of the present invention provide a computer system, method, and computer program product for configuring a computer system. According to one aspect of the present invention, a user can create one or more configuration scripts to perform an automated configuration task on a remote managed computer system and transmit the configuration scripts via a simple object access protocol (SOAP) connection. A user of the remote managed computer system can choose to perform actions of the configuration task on an action-by-action basis by executing one or more of the configuration scripts. The creator of the configuration scripts need not have authority (e.g., need not have administrative privileges) to execute the configuration scripts on the managed computer system.

### TECHNICAL FIELD

The present invention relates generally to computer systems and, more particularly, to configuring computer systems by transmitting configuration scripts via simple object access protocol (SOAP) connections.

### BACKGROUND

Distributed computer systems are increasingly being utilized to provide web services and enterprise-level applications, and to perform distributed computing tasks. In a typical distributed computer system, multiple computer systems (i.e., nodes) are networked and are managed by an administrator. Often, configuration tasks may need to be performed on the nodes, such as upgrading software components and modifying system settings.

One technique for performing such configuration tasks is to manually perform the configuration task on each node. For example, a user with administrative privileges (e.g., a system administrator of the distributed computer system) may remotely connect to each node or physically access each node to install new software. This technique can be time-consuming and labor-intensive, particularly where a distributed computer system includes many nodes, or where a configuration task is complicated.

Another technique for performing configuration tasks is to install specialized components on each node to automate configuration tasks. For example, a dedicated software agent can be installed on each node to perform configuration tasks when initiated by a system administrator, or at a scheduled time. This technique can be less time-consuming than manual configuration, but it may not afford much control over how the configuration task is performed on each specific node. In addition, each of these techniques may require administrative privileges to create and perform configuration tasks on a node.

### SUMMARY

Embodiments of the present invention provide a computer system, method, and computer program product for configuring a computer system. According to one aspect of the present invention, a method is provided comprising: a first computer system receiving from a first user a configuration task to be performed by a second user on a second computer system, wherein the configuration task comprises one or more actions; the first computer system generating one or more scripts to be on the second computer system to perform the one or more actions of the configuration task on an action-by-action basis; and the first computer system transmitting the one or more scripts via a simple object access protocol (SOAP) connection to a third computer system for deployment to the second computer system.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart illustrating operational steps for creating and transmitting a configuration file in accordance with an embodiment of the present invention.

FIG. 3 is a flowchart illustrating operational steps for receiving and executing a configuration file in accordance with an embodiment of the present invention.

FIG. 4 is a block diagram of internal and external components of the computer systems of FIG. 1 in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “system,” or “apparatus”. Furthermore, aspects of the present invention may take the form of a computer program product embodied in one or more computer-readable mediums having computer-readable program code embodied thereon.

Any combination of one or more computer-readable media may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device. A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Briefly, embodiments of the present invention enable a user to create one or more configuration scripts to perform automated configuration tasks on a remote managed computer system. The configuration scripts are transmitted via simple object access protocol (SOAP) connections to a repository for deployment to the managed computer system. The user who creates the configuration scripts does not need authority (e.g., administrative privileges) to execute the configuration scripts on the managed computer system, nor does the user need to utilize a computer system that is part of a managed computer environment with the managed computer system. The configuration scripts can be customized for the managed computer system, and a user of the managed computer system can perform the configuration task on a step-by-step basis by executing the configuration scripts.

Embodiments of the present invention will now be described in detail with reference to the accompanying Figures.

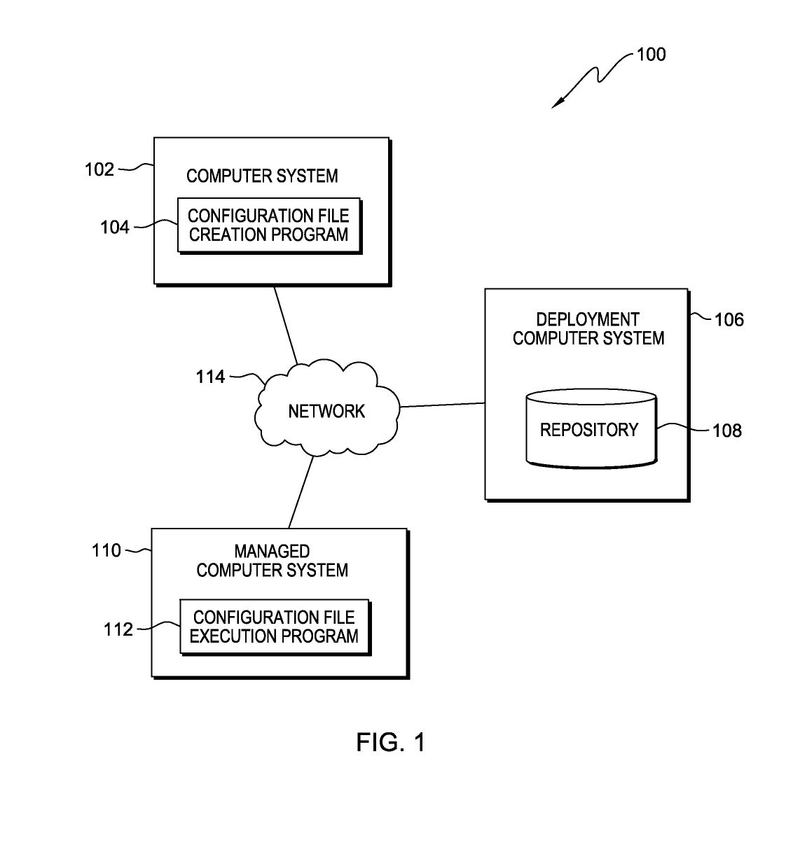

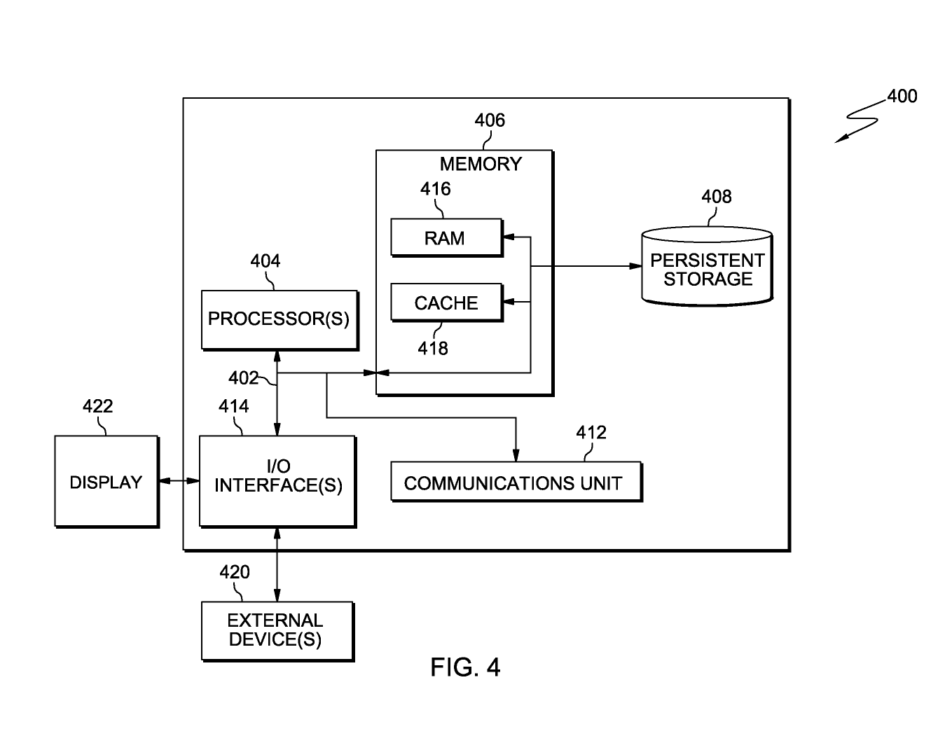

FIG. 1 is a functional block diagram of a data processing environment 100 in accordance with an embodiment of the present invention. Data processing environment 100 includes computer system 102, deployment computer system 106, and managed computer system 110, interconnected over network 114. Computer system 102, deployment computer system 106, and managed computer system 110 can be desktop computers, laptop computers, specialized computer servers, or any other computer systems known in the art. In certain embodiments, computer system 102, deployment computer system 106, and managed computer system 110 represent computer systems utilizing clustered computers and components that each act as a single pool of seamless resources when accessed through network 114. In general, computer system 102, deployment computer system 106, and managed computer system 110 are representative of any electronic devices or combination of electronic devices capable of executing machine-readable program instructions, as described in greater detail with regard to FIG. 4.

Network 114 can be, for example, a local area network (LAN), a wide area network (WAN) such as the Internet, or a combination of the two, and include wired, wireless, or fiber optic connections. In general, network 114 can be any combination of connections and protocols that will support communications between computer system 102, deployment computer system 106, and managed computer system 110 in accordance with a desired embodiment of the invention.

Computer system 102 includes configuration file creation program 104. Configuration file creation program 104 enables a user of computer system 102 to specify one or more configuration tasks to be performed on managed computer system 110, create a configuration file, and transmit the configuration file to deployment computer system 106 via a SOAP connection over network 114. The user of computer system 102, however, does not need to have authority to execute the configuration file on managed computer system 110 (e.g., administrative privileges or permissions), nor does computer system 102 need to be managed together with deployment computer system 106 and managed computer system 110 as part of a managed computer environment.

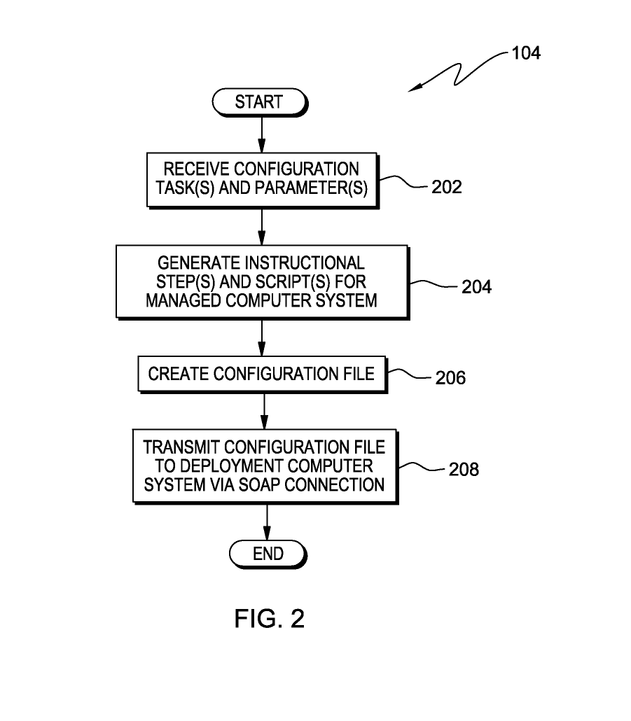

In this exemplary embodiment, the configuration file is an extensible markup language (XML) file that includes one or more instructions, referred to herein as instructional steps or actions, for a configuration task and scripts to perform the configuration task on managed computer system 110. A configuration task can be any task the user of computer system 102 wishes to have performed on managed computer system 110. For example, configuration tasks may include installing software, uninstalling software, changing system settings, copying data, and restarting managed computer system 110. An instructional step includes information to display to the user of managed computer system 110 (e.g., a description or prompt) that is associated with a particular step or action of the configuration task. For example, an instructional step displayed to the user may read “Step 4: Clean up the installation directory,” and may be associated with the step or action of deleting outdated files in the directory in which a particular program file is installed. Configuration tasks and instructional steps can be predefined as part of configuration file creation program 104 and/or they can be manually constructed or otherwise specified by the user of computer system 102. Configuration file creation program 104 is discussed in greater detail with regard to FIG. 2.

Deployment computer system 106 includes repository 108. Repository 108 stores configuration files received from computer system 102 via SOAP connections over network 114. In this exemplary embodiment, deployment computer system 106 and managed computer system 110 are part of a managed computer environment, in which deployment computer system 106 maintains repository 108 and serves as a centralized location for files for managed computer system 110. For example, deployment computer system 106 and managed computer system 110 can be part of an IBM® WebSphere® Application Server environment, where deployment computer system 106 serves as a deployment manager and administration point of a cell (i.e., group of nodes) that includes managed computer system 110.

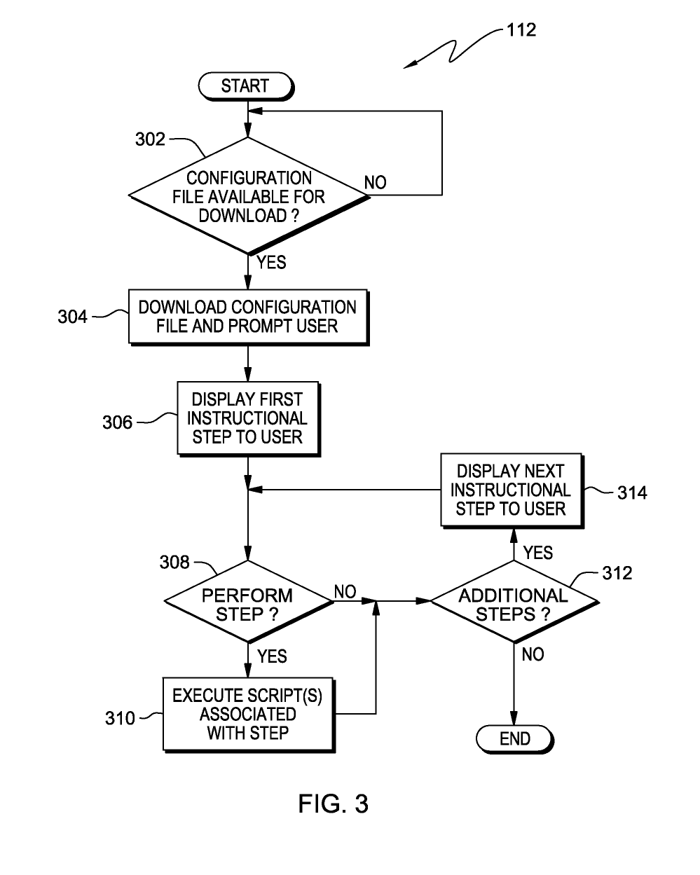

Managed computer system 110 includes configuration file execution program 112. Configuration file execution program 112 enables a user of managed computer system 110 to download configuration files from deployment computer system 106 and execute the configuration files in accordance with embodiments of the present invention. More specifically, configuration file execution program 112 enables the user to view the instructional steps and optionally execute the scripts within a configuration file to perform steps of a configuration task on a step-by-step basis. Configuration file execution program 112 is discussed in greater detail with regard to FIG. 3.

It should be understood that, for illustrative purposes, FIG. 1 does not show other computer systems and elements which may be present when implementing an embodiment of the present invention. For example, managed computer system 110 can be one of multiple computer systems in a managed computer environment being administered by deployment computer system 106.

FIG. 2 is a flowchart illustrating operational steps of configuration file creation program 104 for creating and transmitting a configuration file in accordance with an embodiment of the present invention. In this exemplary embodiment, configuration file creation program 104 provides a graphical user interface (e.g., a wizard) with which the user can interact to create the configuration file. In step 202, configuration file creation program 104 receives one or more configuration tasks and one or more parameters. Parameters can include any data necessary to accomplish the configuration tasks, including the managed computer system on which to perform the configuration tasks. For example, the configuration task may involve installing a software upgrade, and the user may specify parameters including system specifications for managed computer system 110 (e.g., a unique identifier, operating system and processor type) and the file name and location of the software installer.

In step 204, configuration file creation program 104 generates one or more instructional steps and one or more scripts for managed computer system 110. Each script includes one or more commands that, when executed on managed computer system 110, perform a step of the configuration task. Configuration file creation program 104 generates instructional steps and scripts that are customized based on the configuration tasks and parameters specified by the user in step 202. For example, installing the software upgrade may involve customized instructional steps and scripts to perform the steps of: downloading the appropriate software installer file for the specified operating system and processor type of managed computer system 110; locating the downloaded installer file in the default download directory on managed computer system 110 and executing the installer file; and rebooting managed computer system 110.

In step 206, configuration file creation program 104 creates a configuration file containing the one or more instructional steps and scripts that were generated in step 204. In this exemplary embodiment, configuration file creation program 104 creates an XML file, as previously discussed.

In step 208, configuration file creation program 104 transmits the configuration file to deployment computer system 106 via a SOAP connection over network 114. In this exemplary embodiment, configuration file creation program 104 transmits the XML file with an HTTP POST request to deployment computer system 106, and deployment computer system 106 stores the XML file in repository 108.

Accordingly, in this exemplary embodiment, a user of computer system 102 can interact with a user interface to create a configuration file containing one or more configuration tasks that the user wishes to have performed on managed computer system 110, and transmit the configuration file to deployment computer system 106 via a SOAP connection. The user of computer system 102 does not need authority to execute the configuration file on managed computer system 110 (e.g., administrative permissions), and computer system 102 does not need to be a node that is part of the managed computer environment that includes deployment computer system 106 and managed computer system 110. Further, by utilizing a SOAP connection and an HTTP transport protocol, the configuration file can be transmitted to deployment computer system 106 in a standardized format and through any existing firewalls, without requiring modifications to the network infrastructure of the managed computer environment.

FIG. 3 is a flowchart illustrating operational steps of configuration file execution program 112 for receiving and executing a configuration file in accordance with an embodiment of the present invention. In step 302, configuration file execution program 112 periodically queries repository 108 to determine whether a configuration file is available for download. That is, configuration file execution program 112 “listens” for available configuration files that may have been pushed to deployment computer system 106. If configuration file execution program 112 determines that there is a configuration file available for download, then, in step 304, configuration file execution program 112 downloads the configuration file and prompts the user of managed computer system 110. In this exemplary embodiment, a graphical user interface with which the user can interact (e.g., a wizard or info center) is displayed to prompt the user.

In step 306, configuration file execution program 112 displays the first instructional step in the configuration file to the user. For example, as previously discussed with regard to FIG. 2 and the configuration task of installing a software upgrade, the first instructional step in the configuration file may instruct the user to download the appropriate software installer file, and include information that is specific to the operating system and processor type of managed computer system 110.

In step 308, configuration file execution program 112 waits for the user's decision to either perform or skip the step that corresponds to the instructional step displayed to the user. In this exemplary embodiment, the user chooses to perform the step or skip the step by clicking buttons or other selectable elements in the graphical user interface.

If, in step 308, the user decides to perform the step, then, in step 310, configuration file execution program 112 executes the one or more scripts in the configuration file that are associated with the step, such that the step is performed on managed computer system 110.

If, in step 308, the user decides to skip the step, or after step 310 is performed, then, in step 312, configuration file execution program 112 determines whether there are one or more additional steps in the configuration file after the current step. If, in step 312, configuration file execution program 112 determines that there are no additional steps in the configuration file after the current step, then the operational steps end.

If, in step 312, configuration file execution program 112 determines that there are one or more additional steps in the configuration file after the current step, then, in step 314, configuration file execution program 112 displays the next instructional step to the user. After step 314, the operational steps repeat back at step 308, and so repeat for each step in the configuration file. For example, as previously discussed with regard to FIG. 2 and the configuration task of installing a software upgrade, the subsequent steps may involve locating the downloaded installer file in a specific location on managed computer system 110, executing the installer file, and rebooting managed computer system 110.

Accordingly, in this exemplary embodiment, the user of managed computer system 110 interacts with a graphical user interface and decides whether to perform or skip each step in the configuration file on a step-by-step basis. The user can therefore proceed through the steps of the configuration task and, for each step, decide whether to skip the step, perform the step manually, or have the step be performed by configuration file execution program 112. Furthermore, each instructional step and script is customized for managed computer system 110 based on the parameters received during creation of the configuration file, which can enable the user of managed computer system 110 to complete the configuration task with greater ease.

FIG. 4 is a block diagram of internal and external components of computer system 400, such as computer system 102, deployment computer system 106, and managed computer system 110, in accordance with an embodiment of the present invention. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 400 includes communications fabric 402, which provides for communications between one or more processors 404, memory 406, persistent storage 408, communications unit 412, and one or more input/output (I/O) interfaces 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 416 and cache memory 418. In general, memory 406 can include any suitable volatile or non-volatile computer-readable storage media. Software and data necessary to practice embodiments of the present invention are stored in persistent storage 408 for access and/or execution by one or more of the respective processors 404 via one or more memories of memory 406. With respect to computer system 102, such software and data includes configuration file creation program 104. With respect to deployment computer system 106, such software and data includes repository 108. With respect to managed computer system 110, such software data includes configuration file execution program 112.

In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer-readable storage medium that is also part of persistent storage 408.

Communications unit 412 provides for communications with other computer systems or devices via a network. In this exemplary embodiment, communications unit 412 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computer system 400 through communications unit 412 (e.g., via the Internet, a local area network or other wide area network). From communications unit 412, the software and data can be loaded onto persistent storage 408.

One or more I/O interfaces 414 allow for input and output of data with other devices that may be connected to computer system 400. For example, I/O interface 414 can provide a connection to one or more external devices 420 such as a keyboard, computer mouse, touch screen, virtual keyboard, touch pad, pointing device, or other human interface devices. External devices 420 can also include portable computer-readable storage media such as, for example, thumb drives, portable optical or magnetic disks, and memory cards. I/O interface 414 also connects to display 422.

Display 422 provides a mechanism to display data to a user and can be, for example, a computer monitor. Display 422 can also be an incorporated display and may function as a touch screen, such as a built-in display of a tablet computer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description of various embodiments of the present invention has been presented for purposes of illustration and description. It is not intended to be exhaustive nor limit the invention to the precise form disclosed. Many modifications and variations of the present invention are possible. Such modifications and variations that may be apparent to a person skilled in the art of the invention are intended to be included within the scope of the invention as defined by the accompanying claims.

What is claimed is:

1. A method for configuring a computer system, the method comprising:
a first computer system receiving from a first user a configuration task to be performed by a second user on a second computer system, wherein the configuration task comprises one or more actions;
the first computer system generating one or more scripts to be on the second computer system to perform the one or more actions of the configuration task on an action-by-action basis; and
the first computer system transmitting the one or more scripts via a simple object access protocol (SOAP) connection to a third computer system for deployment to the second computer system.

2. The method of claim 1, further comprising:
the second computer system receiving the one or more scripts from the third computer system;
the second computer system providing a user interface with which the second user can choose whether to perform each action of the configuration task on an action-by-action basis; and
responsive to the user choosing to perform a particular action of the configuration task, the second computer system executing one or more of the received one or more scripts.

3. The method of claim 1, wherein the one or more scripts are contained in an extensible markup language (XML) file.

4. The method of claim 1, wherein the one or more scripts generated by the first computer system are customized for the second computer system.

5. The method of claim 1, wherein the first user does not have authority to execute the one or more scripts on the second computer system.

6. The method of claim 1, further comprising:
the first computer system generating one or more instructions for display to the second user that are associated with the one or more actions of the configuration task.

7. A method for configuring a computer system, the method comprising:
a first computer system receiving one or more scripts from a second computer system that, when executed on the first computer system, perform one or more actions of a configuration task;
the first computer system providing a user interface with which a user of the first computer system can choose whether to perform each action of the configuration task on an action-by-action basis; and
responsive to the user of the first computer system choosing to perform a particular action of the configuration task, executing one or more of the scripts in the configuration file on the first computer system.

8. The method of claim 7, wherein the received one or more scripts are generated by a third computer system and are transmitted to the second computer system via a simple object access protocol (SOAP) connection.

9. The method of claim 7, wherein the received one or more scripts are contained in an extensible markup language (XML) file.

10. The method of claim 7, wherein the received one or more scripts are customized for the first computer system.

11. The method of claim 7, wherein the configuration task is specified by a user that does not have authority to execute the received one or more scripts on the first computer system.

12. The method of claim 7, further comprising:
the first computer system receiving one or more instructions for display to the user of the first computer system that are associated with the one or more actions of the configuration task.

13. A computer program product for configuring a computer system, the computer program product comprising:
one or more computer-readable storage media and program instructions stored on at least one of the one or more computer-readable storage media, the program instructions comprising:
program instructions to receive one or more scripts from a second computer system that, when executed, perform one or more actions of a configuration task;
program instructions to provide a user interface with which a user can choose whether to perform each action of the configuration task on an action-by-action basis; and
program instructions to, responsive to the user choosing to perform a particular action of the configuration task, execute one or more of the scripts in the configuration file.

14. The computer program product of claim 13, wherein the received one or more scripts are generated by a third computer system and are transmitted to the second computer system via a simple object access protocol (SOAP) connection.

15. The computer program product of claim 13, wherein the received one or more scripts are contained in an extensible markup language (XML) file.

16. The computer program product of claim 13, wherein the received one or more scripts are customized for a specific computer system.

17. The computer program product of claim 13, wherein the configuration task is specified by a user that does not have authority to execute the received one or more scripts.

18. The computer program product of claim 13, further comprising program instructions to:
receive one or more instructions for display to the user that are associated with the one or more actions of the configuration task.
